(19) United States
(12) Patent Application Publication
(10) Pub. No.: US 2026/0323526 A1
(43) Pub. Date: Oct. 15, 2026

(54) POWER-LIMITED ZONES IN COMMUNICATION SYSTEMS

(71) Applicant: Nokia Solutions and Networks Oy, Espoo (FI)

(72) Inventors: Stephan SAUR, Stuttgart (DE); Thorsten WILD, Stuttgart (DE); Silvio MANDELLI, Stuttgart (DE)

(21) Appl. No.: 19/636,600

(22) Filed: Apr. 1, 2026

(30) Foreign Application Priority Data
Apr. 11, 2025 (FI) 20255334

(51) Int. Cl. H04W 52/06; H04W 4/021; H04W 52/18

(52) U.S. Cl. CPC H04W 52/06; H04W 4/021; H04W 52/18

(57) ABSTRACT

An apparatus including at least one processor and at least one memory storing instructions, when executed by the at least one processor, cause the apparatus to at least receive, from a network node, a first information associated with a target in an environment, the first information including one or more parameter estimates based on a reflection signal from the target; receive, from the network node, a second information associated with the environment and antenna characteristics of a transmission and reception point of the network node; determine a three-dimensional map based on the second information; estimate a position of the target based on the first information and the second information, the estimated position representing a coordinate in the three-dimensional map; and determine a power-limited zone based on the estimated position, the power-limited zone representing restricted capabilities of the network node for sensing the target.

### TECHNICAL FIELD

The disclosure relates generally to integrated sensing and communication systems (ISAC).

### BACKGROUND

It is expected that in future 5G and 6G mobile networks systems will support integrated sensing and communication systems. Network nodes, such as a fifth-generation base station (gNB), are to be equipped with a transmission and reception point (TRP) including an antenna array in order to transmit an incident signal to an object of interest and receive a signal reflected from the object.

### SUMMARY OF THE INVENTION

In a first aspect provided is an apparatus. The apparatus includes at least one processor and at least one memory storing instructions, when executed by the at least one processor, cause the apparatus to at least: receive, from a network node, a first information associated with a target in an environment, the first information including one or more parameter estimates based on a reflection signal from the target; receive, from the network node, a second information associated with the environment and antenna characteristics of a transmission and reception point of the network node; determine a three-dimensional map based on the second information; estimate a position of the target based on the first information and the second information, the estimated position representing a coordinate in the three-dimensional map; determine a power-limited zone based on the estimated position, the power-limited zone representing restricted capabilities of the network node for sensing the target.

According to an example of the first aspect, the one or more parameter estimates include at least one of the following: radar cross section of the target, and/or the radar cross section including size or an interval of size of the target; and optionally reflection and absorption capabilities of the target; and/or transmit power of the reflection signal; and/or carrier frequency of the reflection signal; signal-to-noise ratio (SNR) of the reflection signal; and/or distance between the transmission and reception point and the target.

According to an example of the first aspect, the antenna characteristics include at least one of: number of rows and columns of an antenna array; orientation of the antenna array; three-dimensional position of the antenna array; number of antennas associated with a row of the antenna array; spacing between antennas associated with the row of the antenna array; number of antennas associated with a column of the antenna array; and spacing between antennas associated with the column of the antenna array.

According to an example of the first aspect, the power-limited zone is determined based on a first threshold associated with SNR of the reflection signal, and the apparatus is further caused to determine whether the estimated position is in the power-limited zone.

According to an example of the first aspect, the apparatus is further caused to combine the first information with a predefined target information to obtain an updated first information.

According to an example of the first aspect, the apparatus is further caused to estimate at least one of the following: speed of the target; or moving direction of the target; or orientation of the target.

According to an example of the first aspect, the apparatus is further caused to receive, from the network node, an update representing a change in the antenna characteristics; and modify the second information in accordance with the received update.

According to an example of the first aspect, the apparatus is further caused to determine a power-critical zone for the target, based on a second threshold associated with SNR of the reflection signal, the second threshold being greater than the first threshold; and determine whether the estimated position is in the power-critical zone.

According to an example of the first aspect, the apparatus is further caused to predict a position of the target; determine whether the predicted position is in the power-limited zone or the power-critical zone; predict a trajectory for the target based on the predicted position being in the power-critical zone, and determine whether the predicted trajectory intersects with the power-limited zone.

According to an example of the first aspect, the apparatus is further caused to identify a second network node based on the estimated position or the predicted position being in the power-limited zone; or based on the predicted trajectory intersecting with the power-limited zone.

According to an example of the first aspect, the apparatus is further caused to determine a sensing services handover from the first network to the second network node; transmit a sensing services initialization request to the second network node in order to enable the second network node to sense the target; receive a confirmation for the sensing services initialization request from the second network node; and transmit a sensing services release request to the first network node in order to disable the first network node from sensing the target.

According to an example of the first aspect, the sensing services initialization request includes the estimated position of the target; the estimated speed of the target; the estimated moving direction of the target; the orientation of the target; recommended link parameters. According to an example of the first aspect, the target is an unmanned aerial vehicle (UAV) or a drone.

In a second aspect provided is a method. The method includes: receiving, from a network node, a first information associated with a target in an environment, the first information including one or more parameter estimates based on a reflection signal from the target; receiving, from the network node, a second information associated with the environment and antenna characteristics of a transmission and reception point of the network node; determining a three-dimensional map based on the second information; estimating a position of the target based on the first information and the second information, the position representing a coordinate in the three-dimensional map; determining a power-limited zone based on the estimated position, the power-limited zone representing restricted sensing capabilities of the network node for sensing the target.

In a third aspect provided is a computer-readable medium. The computer-readable medium storing instructions, when executed by an apparatus, cause the apparatus to perform at least: receiving, from a network node, a first information associated with a target in an environment, the first information including one or more parameter estimates based on a reflection signal from the target; receiving, from the network node, a second information associated with the environment and antenna characteristics of a transmission and reception point of the network node; determining a three-dimensional map based on the second information; estimating a position of the target based on the first information and the second information, the position representing a coordinate in the three-dimensional map; determining a power-limited zone based on the estimated position, the power-limited zone representing restricted sensing capabilities of the network node for sensing the target.

### BRIEF DESCRIPTION OF THE DRAWINGS

FIG. 1 depicts an exemplary environment in accordance with various aspects of the disclosure.

FIG. 2 depicts an exemplary environment in accordance with various aspects of the disclosure.

FIG. 3 depicts an exemplary network node device in accordance with various aspects of the disclosure.

FIG. 4 depicts an exemplary apparatus in accordance with various aspects of the disclosure.

FIG. 5 depicts an exemplary process and signaling scheme in accordance with various aspects of the disclosure.

FIG. 6 depicts an exemplary method in accordance with various aspects of the disclosure.

### DETAILED DESCRIPTION

Reference will now be given in accordance with the aspects, examples of which are illustrated in the accompanying drawings. The detailed description provided below in conjunction with the appended drawings is intended as a description of the present examples and is not intended to represent the only forms in which the present example may be constructed or utilized. The description sets forth the functions of the example and the sequence of processes for constructing and operating the example. However, the same or equivalent functions and sequences may be accomplished by different examples.

The word “exemplary” (and as well as “exemplarily”) is used herein to mean “serving as an example, instance, or illustration”. Any embodiment or design described herein as “exemplary” (and “exemplarily”) is not necessarily to be construed as preferred or advantageous over other embodiments or designs.

The term “data fusion” may refer to or include combining data from multiple sources (e.g. multiple sensors) providing structured, semi-structured or unstructured data in order to form a more comprehensive data set. Such “data fusion” may be implemented in order to exemplarily combine raw data, or at a higher level, to make a decision, etc.

The term “modality” may refer to or include a particular type or mode of the expression of the data. In such a sense, the “modality” may be the type of a data perceived and interpreted by a system. Exemplarily, an image may be considered to have a modality different than the modality represented by a sound. Therefore, “modality” should be understood as a characteristic of a feature.

The term “multi-modal” (as well as “multi-modality”) may refer to or include different modalities represented by different characteristics of different features potentially derived and/or extracted from different sources. For example, different types of sensors may provide different features and therefore different modalities. Such different modalities may be attempted to be merged (e.g. by way of feature fusion) within an environment or framework which effectively makes that environment/framework “multi-modal”.

The term “latent space” may refer to or include an internal interpretation of a high-dimensional data in order to represent the discriminative features of the high-dimensional data in a low-dimensional space. Such low-dimensional space may be the “latent space”. A discriminative feature may include e.g. a feature vector associated with the high-dimensional data.

In the context of integrated sensing and communication (ISAC) systems, a network node (i.e. sensing network node) may play a crucial role in bridging the gap between the physical world and the digital realm. These network nodes may be equipped with sensors that are capable of detecting and measuring various physical parameters including, but not limited to, temperature, pressure, light intensity, or motion. They may act as critical actors of the system, collecting data from an environment and converting it into digital signals.

These nodes may typically be integrated with communication capabilities, allowing them to transmit e.g. the collected data to a central entity or other sensing network nodes. This integration may enable the system to perform both sensing and communication tasks simultaneously, leveraging the same infrastructure for both functions. This approach offers significant advantages in terms of efficiency, cost-effectiveness, and flexibility, as it eliminates the need for separate sensing and communication networks.

Various aspects of the disclosure may relate to mono-static sensing. Mono-static sensing may refer to a configuration where a single network node (e.g. sensing network node) acts as both the transmitter and receiver of sensing signals. This approach may simplify the system architecture and reduce the overall hardware complexity, making it particularly suitable for applications where e.g. resource constraints are a concern. In mono-static sensing, the network node may transmit a sensing signal, such as a pulse, an incident signal, or an acoustic wave, etc. towards an object of interest, which may be denoted as the target. The reflected signal from the target may then be received by the same network node, allowing it to extract information about the target's properties, such as its distance, velocity, or material composition. This approach is commonly used in applications like object detection, target tracking, and environmental monitoring, where the sensing node needs to operate autonomously and efficiently.

Various aspects of the disclosure may give reference to a transmission and reception point (TRP) within the context of mono-static sensing. TRP may take on a dual role, acting as both the source of the sensing signal (i.e. incident signal) and the receiver of the reflected signal (i.e. reflection signal). TRP may transmit the incident signal propagating through the environment and interacting with the target, causing a portion of it to be reflected back towards the source (i.e. sensing network node). TRP may then receive the reflected signal, which carries information about the target's properties. By analyzing the characteristics of the received signal, such as its time of arrival, amplitude, and phase, the system can extract information about the target's distance, velocity, speed, and/or material composition. Such integrated approach may simplify the overall system architecture and reduce hardware complexity, making it particularly suitable for resource-constrained applications. In some aspects, the incident signal may refer to or include any type of signal transmitted from the TRP, such as a reference signal. Therefore, incident signal may be thought as a transmitted signal that is to reflect back from an object. In such way, it may be possible to demonstrate a pair of signals within this context where the incident signal would be the signal transmitted and the reflection signal would be the signal ‘bounced’ back from the target once the incident signal ‘collides’ with the object (i.e. the target).

Various aspects of the disclosure may relate to ISAC within the context of radio access technologies, such as 5G Advanced. Exemplarily, 5G Advanced is expected to enable more precise and reliable sensing through improved signal processing techniques, higher bandwidth, and more sophisticated algorithms. This is expected to allow for more accurate object (e.g. target) detection, localization, and environmental monitoring. 5G Advanced is further expected to facilitate the transmission of larger volumes of sensing data at higher speeds, enabling real-time (or near real-time) analysis and decision-making for applications like autonomous driving, military, intrusion detection, industrial automation, smart cities, etc. 5G Advanced is further expected to optimize e.g. the integration of sensing and communication functionalities, enabling seamless data exchange and resource allocation between sensing and communication tasks. This will lead to more efficient and effective ISAC systems.

Various aspects of the disclosure may relate to ISAC within the context of other radio access technologies, such as 6G. Exemplarily, 6G is expected to enable the exploration of new sensing modalities, such as terahertz sensing, to enable more precise and detailed environmental monitoring, object detection and/or material characterization, etc. 6G is further expected to enable sensing through physical obstacles, such as walls and buildings, using advanced signal processing techniques and intelligent algorithms. This is likely to open up new possibilities for applications like indoor navigation, disaster response, and/or infrastructure monitoring, etc. In some cases, 6G is to leverage Artificial Intelligence (AI) and Machine Learning (ML) techniques to enhance sensing capabilities, enabling intelligent data analysis, automated target recognition, and adaptive sensing strategies. This is in turn likely to lead to more efficient and effective sensing systems. Although the reference made for RATs like 5G Advanced, and 6G, the disclosure may still relate to other RATs including, but not limited to, 5G (fifth generation), 4G (fourth generation), LTE (long-term evolution), etc.

FIG. 1 illustrates an environment 100. The environment 100 may be populated with a network node 110 including a transmission and reception point (TRP) 112. Although TRP 112 is depicted as a single block on the network node 110, this should not be taken as limiting as TRP 112 may exemplarily be divided into two separate blocks collocated on the network node 110 in which one of them serves a transmission block (i.e. transmission point) for transmitting sensing signals from the network node 110 and the other one serves as a reception block (i.e. reception point) for receiving signals reflected from an object to the network node 110. TRP 112 may include an antenna array with one or more antenna elements. The network node 110 may be deployed on a reference surface 102.

In some cases, the network node 110 may be referred to a sensing network node, in particular with an emphasis on the integrated sensing and communication systems (ISAC). Therefore, a sensing network node (e.g. network node 110) may be capable of sensing a surrounding environment (e.g. environment 100). The network node 110 may illustratively be a fifth-generation base station (gNB) or any other network node intended to be deployed in future generations (e.g. a 6G network node), or a network node equipped with required hardware and/or software components enabling the network node to carry out sensing functionalities of the environment.

The network node 110 may serve with a certain performance within a coverage zone depicted as a zone between borders 104 and 106. The borders 104 and 106 are to be interpreted as for illustrative purposes only to depict a zone where the network node 110 performs well in terms of various known metrics including quality of service (QoS), reference signal received power (RSRP), signal-to-noise ratio (SNR), etc. In various examples, the environment 100 may include an object of interest. Such an object may be a target 120 for the network node 110 to sense.

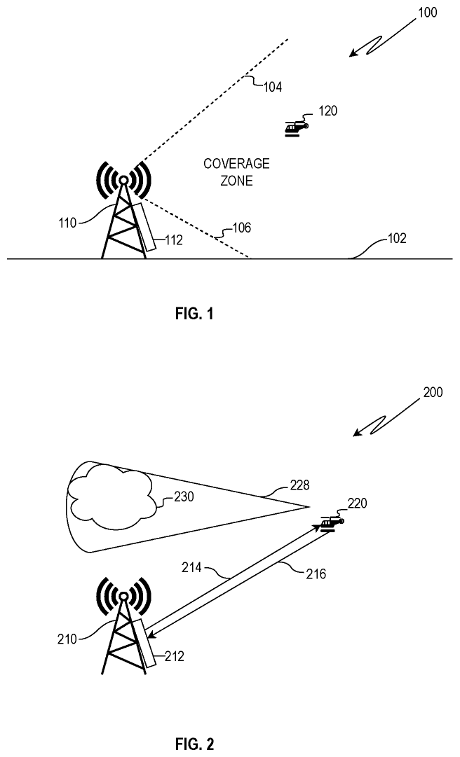

FIG. 2 illustrates an environment 200. The environment 200 may include a network node 210 as a sensing network node and a target 220 within the coverage zone of the network node 210. In some examples, the network node 210 may transmit a incident signal 214 via its TRP 212 (or transmission block of TRP 212) to the surrounding area. In some cases, the incident signal 214 may reflect from surface of the target 220. Such signal may be referred to a reflection signal that can be received by the network node 210, via the TRP 212 (or reception block of the TRP 212). In various examples, SNR of the reflection signal 214 may be above a threshold to indicate that the target 220 is within the coverage zone.

In accordance with various aspects disclosed herein, a power-limited zone may be defined. The power-limited zone may be associated with a zone above the antenna array of a TRP, or a zone behind physical obstacles. A power-limited zone may also be present in proximity of the radio tower on the ground. With a reference to FIG. 1, such power-limited zone may be observed in vicinity of the network node 110 considering the area illustratively defined in-between the reference surface 102 and the border 106, for instance. A prominent example where power-limited zones may be a topic of interest is detection of unmanned aerial vehicles (UAVs, e.g. drones). In contrast to handheld devices (e.g. user devices, mobile phones, etc.) for classical communication services, UAVs can enter locations for which the cellular layout, in particular the supported steering direction of the antenna arrays is not optimal. One example for such a location is directly above the TRP of a sensing node. Overall, the power-limited zone may represent restricted capabilities of the network node for sensing a target (e.g. UAV).

FIG. 2 further illustrates such power-limited zone 230 for the target 220. In some examples, the power-limited zone 230 may indicate a signal power threshold of the reflection signal 216 in which the signal power threshold is attributed to the SNR of the reflection signal 216. In some cases, such threshold may exemplarily be 17 dB. In that sense, the network node 210 may receive, via TRP 212, the reflection signal 216 and the SNR may be estimated based on the reflection signal 216. In some examples, the estimated SNR may be above 17 dB, which may indicate that the target 220 is within the coverage zone of the network node 210. In other examples, the estimated SNR may be below 17 dB, which may indicate that the target 220 is within the power-limited zone 230 of the network node 210.

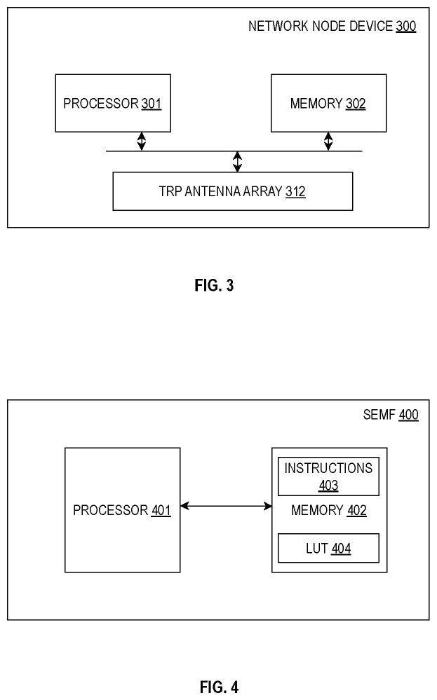

FIG. 3 illustrates a network node device 300 capable of estimating a measurement based on a received signal. In some cases, the network node device may be capable of transmitting an incident signal. Exemplarily, the network node device 300 may include a transceiver (not shown) coupled to one or more antenna elements of the TRP antenna array 312 in order to receive and/or transmit radio frequency signals, signaling information and/or data according to at least one cellular communication protocol. In some aspects, the network device 300 may be included in a network node (e.g. network node 200), or the network device 300 may include the network node.

In an example, the network node device 300 may include a processor 301. the processor 301 may be embodied as a multi-core or a single-core processor, or a possible combination thereof including one or more instances for each type, etc. For example, the processor 301 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. The network node device 300 may further include a memory 302 coupled to the processor 301. The memory 302 may store instructions executable by the processor 301. Additionally, or alternatively, the memory 302 may include a storage that may be used to store e.g., at least some of the information and/or data disclosed herein. The network node device 300 may further include means to facilitate the process of performing estimations (e.g. analog-to-digital converter, digital-to-analog-converter, etc.)

In some cases, the network node device 300 may be enabled to transmit an incident signal to a target. For example, with a reference to FIG. 2, the network node device 300 may cause the network node 210 to transmit the incident signal 214 via the antenna array of the TRP 212. The incident signal 214 may be reflected from the target 220 and the corresponding reflection signal 216 may be received by the TRP 212. The network node device 300 may interact with the TRP to obtain the reflection signal 216 to perform various estimations. In an example, the processor 301 may be configured to estimate the SNR of the reflection signal 216 that indicates whether the target 220 is within the coverage zone of the network node 210.

However, in further examples, estimating a position of the target and determining power-limited zone may require taking various parameters into account e.g. in addition to estimated SNR value of a reflection signal, etc. Because, merely performing an estimation for the target regarding whether it is within the power-limited zone may not provide enough information in the field of target detection, zone detection, relative positioning of the target with respect to the identified power-limited zone, etc. Therefore, an apparatus and a corresponding method may be provided in order to determine target-specific power-limited zones and estimate a position of the target e.g. to figure out whether the target is within such zone or the coverage zone of an associated network node (i.e. sensing network node). In some cases, the apparatus may ensure the continuity of the sensing service in case a target is determined and/or expected to be in the power-limited zone. Such apparatus may be capable of performing various functions disclosed herein with at least one processor and at least one memory that stores instructions executable by the at least one processor.

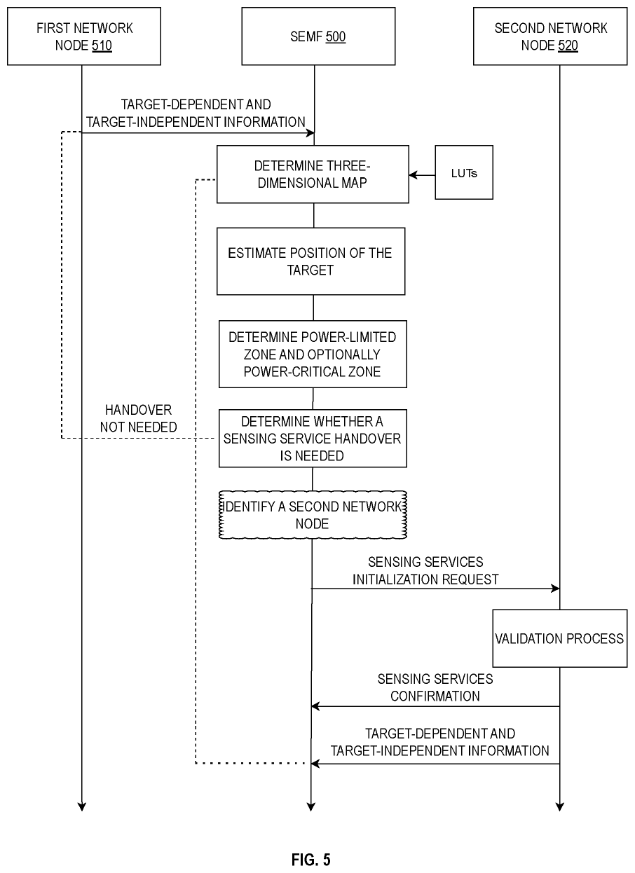

FIG. 4 depicts such an apparatus, which may be referred to as Sensing and Management Function Entity (SEMF) 400. In some cases, SEMF 400 may include a processor 401. The processor 401 may be an at least one processor exemplified for the processor 301, referring to FIG. 3. The SEMF 400 may further include at least one memory 402 coupled to the processor 401. The memory 402 may store instructions 403 executable by the processor 401 to cause the apparatus to perform one or more operations in accordance with the present disclosure. In some examples, the memory 402 may further store a look-up table (LUT) 404 that includes further environment information. Exemplarily, the LUT 404 may contain complementary/supplementary information about an environment (e.g. environment 100, environment 200). In an example, such information may relate to environment information that a sensing network node (e.g. network node 110, network node 210) may not be able to sense due to physical obstacles. In that sense, such complementary/supplementary information may refine the environment information sensed by the corresponding network node.

The memory 402 (also e.g. the memory 302) may be or include one or more volatile memory devices, one or more non-volatile memory devices, and/or a combination of one or more volatile memory devices and nonvolatile memory devices. For example, the memory 204 may be embodied as semiconductor memories (such as mask ROM, PROM (programmable ROM), EPROM (erasable PROM), flash ROM, RAM (random access memory), etc.

In some aspects, the SEMF 400 may determine target-specific power zones (e.g. power-limited zone 230) and position of a target based at least in part on combining target-dependent and target-independent information. In an example and referring to FIG. 2 again, the SEMF 400 may receive one or more parameter estimates from the network node 210 based on the reflection signal 216. In some cases, the one or more parameter estimates may include radar cross-section (RCS) of the target 220 as target-dependent information. RCS of the target 220 may denote a measure of how detectable the target 220 by sensing signals (e.g. reference signals) transmitted by the network node 210. As denoted, the SNR of the reflection signal 216 may also be involved in the received estimates, along with other optional estimates. In some examples, the estimates (i.e. estimations) may be derived from measurements associated with the reflection signal 216.

In an example, power of the reflection signal 216 received by the network node 210 may be computed based on the radar equation:

$${P}_{R} ( r ) {P}_{T} {G}_{T} {G}_{R} Ψ \frac{{c}_{0}^{2}}{4 {π}^{3} {r}^{4} {f}_{c}^{2}}$$

with P_{T}, G_{T}, G_{R} denoting transmit power of the incident signal 214 (i.e. transmission signal), transmit antenna gain and receive antenna gain associated with the TRP 212, respectively. In some cases, product of these three parameters may form effective isotropic radiated power (EIRP) which may be subject to regulations drawn for communication systems. In the equation, r denotes the range, c₀ speed of light and f_{c} carrier frequency. The target-dependent RCS component is denoted as ψ described with the unit m².

Still referring to FIG. 2, the SEMF 400 may obtain or receive target-dependent information (i.e. first information) from the network node 210. As discussed, target-dependent information may include one or more parameter estimates based on the reflection signal 216 reflected from the target 220. The estimates may accordingly include RCS of the target. In some examples, RCS of the target 220 may be represented with an interval denoting estimated RCS with respect to estimated maximum RCS and estimated minimum RCS. The one or more parameter estimates may optionally also include reflection and absorption capabilities of the target 220, transmit power of the reflection signal 216, carrier frequency of the incident signal 214, SNR of the reflection signal 216, distance between the TRP 212 and the target 220. SNR of the reflection signal 216 may be calculated with known operations by dividing the power with average noise, for instance.

In accordance with various aspects of the present disclosure, the SEMF 400 may also receive target-independent information (i.e. second information) from the network node 210. In an example, target-independent information may include information about the environment 200. Furthermore, target-independent information may also include information about antenna characteristics relating to the TRP 212 of the network node 210. Although the target-independent information may be received in a multimodal manner, it may be possible for the SEMF 400 to receive target-independent information separate from each other and use that information separately or in a combined manner. For cases in which the SEMF 400 retrieves the target-independent information as having multimodality, the SEMF 400 may map the corresponding information to corresponding latent spaces to obtain respective information e.g. for antenna characteristics of the TRP 212 and for the environment 200.

In accordance with various aspects disclosed herein, a sensing network node (e.g. network node 110, network node 210), such as a gNB or more generally a base station with sensing capabilities, may be considered primary sources for data acquisition and collection. In some cases, sensing network nodes may be able perform data fusion in order to provide a comprehensive information about the environment and the anchors that populate the environment. In some cases, a sensing network node may also be able to store data about the certain and various characteristics of itself, which may be fused with sensing data for a more accurate approximation or may be categorized as e.g. non-sensing data to provide a distinction from the sensing data. However, regardless of the type of data, such information may be utilized separately or fused at a different entity or at the network node itself.

Antenna characteristics of the TRP 212 may help the SEMF 400 to ease ambiguities that may be presented in the (one or more) parameter estimates. Therefore, obtaining such information may lead the SEMF 400 to estimate a position of the target 220 in a more accurate manner. Exemplarily, the radiation pattern of the antenna array of the TRP 212 may be determined for both transmission (e.g. of the incident signal 214) and reception (e.g. of the reflection signal 216). In such sense, it may be understood as an amplification factor of the signal power in a certain direction, for example signal power of the reference (for Tx) or reflection signal (for Rx), which depends on complex factors per antenna element of the antenna array of the TRP 212. From that, it may be derivable a sector (i.e. azimuth and elevation) with respect to the TRP 212, allowing for refined estimation of position of the target 220.

In some cases, the term antenna characteristics may refer to or include one or more of a number of rows and columns of an antenna array; orientation of the antenna array; three-dimensional position of the antenna array; number of antennas associated with a row of the antenna array; spacing between antennas associated with the row of the antenna array; number of antennas associated with a column of the antenna array; and spacing between antennas associated with the column of the antenna array in which the antenna array may stand for the TRP's antenna array.

In some examples, the SEMF 400 may determine a three-dimensional map based on the target-independent information. Such coverage map may include or may be constituted by the points in space. The SEMF 400 may assign each point a value representing the power of the received signal. The power of the received signal may be dependent on the transmit power of a corresponding signal, distance between the point and the TRP 212, azimuth and elevation angle of the point with respect to the TRP 212, orientation of the antenna array of the TRP 212 which may include horizontal boresight direction and mechanical tilt, and the like; the beamforming weights, number of sensing radio resources in time and frequency, etc. The three-dimensional map may include grids formed by the points, and corresponding values for each grid may be precalculated and stored in the memory 402 of the SEMF 400. Therefore, it should be appreciated that the three-dimensional map may be valid for all targets within an environment (e.g. environment 200). In some aspects, each point or each grid may be attributed to a coordinate in the three-dimensional map.

Some of the parameters that have an impact on the value (i.e. received signal power) may change over time. Exemplarily, number of sensing radio resource may depend on the traffic load of the TRP 212. In such case, the network node 210 may inform the SEMF 400 about this change, and the SEMF 400 may update the three-dimensional map in accordance with this change. In some cases, the SEMF 400 may determine the three-dimensional map based on the most likely settings stored within the memory 402 in order not to be affected by continuous changes, for example. Additionally, or alternatively, the SEMF 400 may determine the three-dimensional map by leveraging a stored information in the LUT 403 about the environment 200. The SEMF 400 may also use the complementary environment information in the LUT 403, which may result in more accurate representation of the environment 200.

As denoted, the SEMF 400 may determine position of the target 220 based on both target-dependent and target-independent information. The position of the target 220 may be referred to as estimated position which may indicate a coordinate in the three-dimensional map. In some examples, the SEMF 400 may store a predefined target information e.g. within the memory 402. The predefined target information may be preset RCS of the target. Exemplarily, the target may be a drone with an average RCS of 0.1 Ψ [m²] as prestored information. In such case, the SEMF 400 may refine the RCS of the target 220 using the radar equation based on the estimates. Such an approach may result in more accurate estimate of the position of the target 220 as the SEMF 400 may be able to iteratively converge to the RCS by leveraging the prestored information and the one or more parameter estimates, rather than solely relying on the estimated measurements alone. In other words, the prestored RCS may subject to an update based on the one or more parameter estimates and the SEMF 400 may estimate the position based at least in part on the updated RCS.

Still referring to FIG. 2 and FIG. 4 collectively, the SEMF 400 may determine a power-limited zone 230 for the target 220. The power-limited zone may be referred to or include ensemble of points and/or grids or coordinates in the three-dimensional map. As defined, the three-dimensional map could be valid for all targets within e.g. environment 200, as it may be formed based on the target-independent information, e.g. environment, precalculated functions stored in the memory 402, etc. Considering the radar equation, and precalculated functions for a previously known target (or previously known type of target), the three-dimensional map may include a score for each point (or each grid or each coordinate) defined by SNR term (i.e. estimated SNR in the receive signal) divided by the RCS term Ψ.

The SEMF 400 may determine an area-of-interest 228 based on the estimated position of the target 220. Exemplarily, the SEMF 400 may define and/or mark certain points/coordinates in vicinity of the coordinate of the estimated position as area-of-interest 228. The area-of-interest 228 in this context may refer to e.g. an expected flight corridor of the target 220, potential coordinates that the target 220 may be at in time, etc. The SEMF 400 may aim to determine the power-limited zone 230 within the area-of-interest 228. Therefore, the SEMF 400 may extract the scores corresponding to the points and/or coordinates relating to the area-of-interest 228 from the three-dimensional map. The SEMF 400 may multiply the scores with the estimated RCS received from the network 210 in linear scale to compute SNR values for the points/coordinates of the area-of-interest 228. In some examples, the estimated RCS may be replaced with an interval with borders defined by estimated maximum RCS and minimum RCS, as the orientation of the target 220 with respect to the TRP 212 and therefore perceived RCS of the target 220 may change during target's movement. In some examples, SNR computing may be replaced by signal-to-noise plus interference (SINR) computing. The SEMF 400 may compare the computed SNR values with a threshold (e.g. a first threshold), such as 17 dB. Therefore, the points/coordinates corresponding to the area-of-interest 228 with a computed SNR below the threshold may form or constitute the power-limited zone 230.

In some cases, the SEMF 400 may obtain the target-dependent and target-independent information from the network node 210 periodically. That is, the SEMF 400 may periodically retrieve the corresponding information which may lead to an update in the three-dimensional map and/or the estimated position. Such modifications may accordingly alter e.g. the area of interest and/or the power-limited zone 230 due to a potential update in e.g. the estimated position of the target 220. Exemplarily, at a first time instance to, the SEMF 400 may estimate a first position of the target 220 in the three-dimensional map and, at a second time instance t₁, the SEMF 400 may estimate a second position of the target 220. In some aspects, the second position of the target 220 may be different from the first position and, based on those positional differences on three-dimensional axes for a given time period (e.g. t₁-t₀), the SEMF 400 may estimate speed of the target 220 and/or moving direction of the target 220 and/or orientation of the target 220 with respect to the TRP 212.

It may not be always possible for the SEMF 400 to detect the target 220 and confer a position. This may be due to azimuth and/or elevation angles exceed a threshold depending on e.g. the subcarrier spacing and/or the antenna element spacing of the TRP 212. If the threshold is exceeded such way, conditions for a range unambiguity for sensing the target may be violated and target detection may become impossible. Therefore, all points exceeding such threshold to present ambiguity (e.g. due to aliasing) for detection of the target may be excluded in the three-dimensional map. Such limitations for providing unambiguity may be assumed to be constant over a long time and may be stored in a look-up table in the SEMF 400. An update of the excluded points is necessary, if the antenna array is replaced or mechanically adjusted. Exemplarily, if the antenna array of the TRP 212 is replaced or mechanically adjusted, the excluded points may need an update since azimuth and/or elevation angles were subject to a change due to this operation.

Keeping on with FIG. 2, the SEMF 400 may determine a power-critical zone (not shown), different from the power-limited zone 230. In some examples, Following the SEMF 400 estimating the position of the target 220 and identifying the area-of-interest 228, it may determine a power-critical zone based on another threshold (e.g. a second threshold) compared to the threshold (i.e. the first threshold exemplified as 17 dB) used for determining the power-limited zone 230. Exemplarily, the SEMF 400 may determine the power-critical zone according to a threshold several dBs greater than the first threshold (e.g. 20 dB). Therefore, the power-critical zone may include the power-limited zone 230 as it contains all the points/grids/coordinates of the power-limited zone as well as the points that fall under the in-between values of the first threshold (e.g. 17 dB) and the second threshold (20 dB). Illustratively, a point (or grid, coordinate) in the three-dimensional map may be assigned e.g. 19 dB. Thus, if the SEMF 400 determines that such point is within the area-of-interest 228, then this point may be referred to as part of the power-critical zone. It could be immediately understood that the network node 210 may still sense a target within the corresponding power-critical zone as unambiguity measures still hold. That is, sensing capabilities of a network node (e.g. network node 210) may not be as restricted for sensing a target within the corresponding power-critical zone compared to the restricted sensing capabilities for a target within the corresponding power-limited zone (e.g. power-limited zone 230). However, it may be desirable for the SEMF 400 to trigger an action in order to ensure sensing service continuity, in case the target (e.g. target 220) moves towards the corresponding power-limited zone.

FIG. 5 depicts a process with signaling that may occur between a network node 510, 520 (i.e. sensing network node) and a SEMF 500, which may incorporate the features and functionalities of e.g. SEMF 400 illustrated in FIG. 4. As discussed, the SEMF 500 may receive target-dependent information (i.e. first information) and target-independent information (i.e. second information from the network node 510. Based on the target-independent information, the SEMF may determine a three-dimensional map considered to be valid for and/or relevant to one or more targets observable in an environment (e.g. environment 100, environment 200, etc.). In some cases, the SEMF 500 may leverage additional information about the environment, such as physical obstacles and entities not sensible by the network node 510, obtainable from one or more look-up-table(s) (LUTs). In that sense, the SEMF 500 may refine the three-dimensional map in order to create a more accurate representation of the environment, in a similar fashion disclosed earlier herein.

The SEMF 500 may proceed with performing similar processes described in conjunction with e.g. FIG. 2, including estimating a position of the target, and determining power-limited zone for the target based on the estimated position. In some aspects, the SEMF 500 may optionally determine power-critical zone for the target as well. In various cases, the SEMF 500 may determine whether a sensing service handover needed for continuity of the sensing services for the target. Exemplarily, the SEMF 500 may predict a position of the target. Within this context, the predicted position may refer to a position of the target in a time instance occurring later than the time instance for which the estimated position is determined. In other terms, the SEMF 500 may predict a future position of the target. Such prediction may be performable by the SEMF 500, which takes various parameters into account. For example, the SEMF 500 may predict the position based on the estimated position, estimated speed, and estimated orientation, time instance, etc. and may compute a likelihood of one or more candidate coordinates for the future position (i.e. predicted position). In an example, a likelihood of one candidate coordinate may be attributed to a higher score and thereby determined as the predicted position. In some cases, the SEMF 500 may implement one or more machine learning models in order to predict the position of the target. Such models may include supervised, unsupervised, and/or semi-supervised machine learning models that are known in the field.

In accordance with various aspects of the disclosure, the SEMF 500 may determine whether the predicted position is in the power-limited zone. Additionally, or alternatively, the SEMF 500 may further determine whether the predicted position is in the power-critical zone. In an example, the SEMF 500 may determine that predicted position is not in the power-limited zone, but rather in the power-critical zone. In such case, the SEMF 500 may predict a trajectory in the three-dimensional map for the target. The trajectory may be formed by using various computational methods. Illustratively, the SEMF 500 may determine the trajectory by merging points/coordinates that have the highest likelihood score for a given time instance. Therefore, the trajectory may refer to or include one or more coordinates, each predicted for a distinct time instance in the future (e.g. future compared to the time instance for which the position is estimated, i.e. estimated position). In some cases, the SEMF 500 may determine whether the predicted trajectory intersects with the power-limited zone. That is, the SEMF 500 may determine that the one or more coordinates of the predicted trajectory are also included in the power-limited zone.

In some examples, the SEMF 500 may determine that the sensing service handover is required. The SEMF 500 may determine that the estimated position is the power-limited zone and therefore a handover is required. Additionally, or alternatively, the SEMF 500 may determine the predicted position is in the power-limited zone and, based on this, the SEMF 500 may trigger a handover. As another aspect or alternative, the SEMF 500 may determine that the predicted trajectory intersects with the power-limited zone and there is a need for handover. For each scenario described, the SEMF 500 may identify a second network node 520, regarded as a target sensing network node taking over the sensing services from the first network node 510 i.e. source sensing network node.

The SEMF 500 may transmit a sensing services initialization request to the second network node 520 in order to enable the second network node to sense the target and receive a confirmation for the sensing services initialization request from the second network node 520. Such confirmation may require the second network node 520 to validate the request from the SEMF 500. Upon the confirmation received from the second network node 520, the SEMF 500 transmit a sensing services release request to the first network node 510 in order to disable the first network node 510 from sensing the target. In some cases, sensing services initialization request may include the estimated position of the target and/or the estimated speed of the target and/or the estimated moving direction of the target and/or the orientation of the target and/or recommended link parameters. Within the context, link parameters may refer to or include number of radio resources in time and frequency recommended for the sensing service and transmit power (i.e. power of the transmitted signal from the sensing network node).

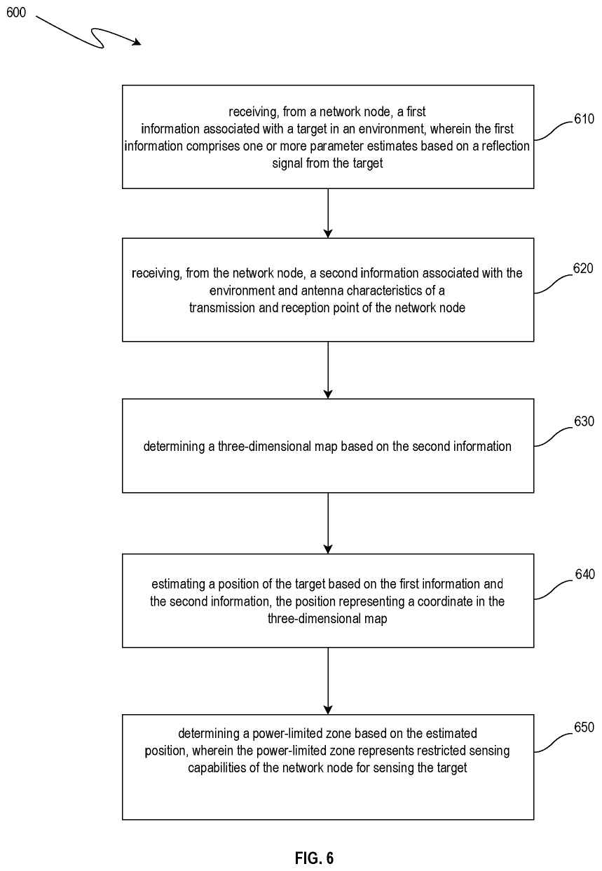

FIG. 6 depicts a method 600 in accordance with various aspects disclosed herein. The method 600 may include, at block 610, receiving, from a network node (e.g. network node 210), a first information associated with a target (e.g. target 220) in an environment (e.g. environment 200), wherein the first information (i.e. target-dependent information) comprises one or more parameter estimates based on a reflection signal from the target. The method 600 may further include, at block 620, receiving, from the network node, a second information (i.e. target-independent information) associated with the environment and antenna characteristics of a transmission and reception point (e.g. TRP 212) of the network node.

The method 600 may further include, at block 630, determining a three-dimensional map based on the second information, and at block 640, estimating a position of the target based on the first information and the second information, the position representing a coordinate in the three-dimensional map. The method 600 may include, at block 650, determining a power-limited zone based on the estimated position, wherein the power-limited zone represents restricted sensing capabilities of the network node for sensing the target.

1. An apparatus comprising:
at least one processor;
at least one memory storing instructions, when executed by the at least one processor, cause the apparatus to at least:
receive, from a network node, a first information associated with a target in an environment, the first information comprising one or more parameter estimates based on a reflection signal from the target;
receive, from the network node, a second information associated with the environment and antenna characteristics of a transmission and reception point of the network node;
determine a three-dimensional map based on the second information;
estimate a position of the target based on the first information and the second information, the estimated position representing a coordinate in the three-dimensional map; and
determine a power-limited zone based on the estimated position, wherein the power-limited zone represents restricted capabilities of the network node for sensing the target.

2. The apparatus of claim 1, wherein the one or more parameter estimates comprise at least one of: radar cross section of the target, the radar cross section comprising size or an interval of size of the target; reflection and absorption capabilities of the target; received power of the reflection signal; signal-to-noise ratio, SNR, of the reflection signal; carrier frequency of the reflection signal; distance between the transmission and reception point and the target.

3. The apparatus of claim 1, wherein the antenna characteristics comprise at least one of: number of rows and columns of an antenna array; orientation of the antenna array; three-dimensional position of the antenna array; number of antennas associated with a row of the antenna array;
spacing between antennas associated with the row of the antenna array; number of antennas associated with a column of the antenna array; and spacing between antennas associated with the column of the antenna array.

4. The apparatus of claim 1, wherein the power-limited zone is determined based on a first threshold associated with SNR of the reflection signal, and wherein the apparatus is further caused to determine whether the estimated position is in the power-limited zone.

5. The apparatus of claim 1, wherein the apparatus is further caused to combine the first information with a predefined target information to obtain an updated first information.

6. The apparatus of claim 1, wherein the apparatus is further caused to estimate at least one of: speed of the target; moving direction of the target; orientation of the target.

7. The apparatus of claim 1, wherein the apparatus is further caused to:
receive, from the network node, an update representing a change in the antenna characteristics; and
modify the second information in accordance with the received update.

8. The apparatus of claim 1, wherein the apparatus is further caused to:
determine a power-critical zone for the target, based on a second threshold associated with SNR of the reflection signal, wherein the second threshold is greater than the first threshold; and
determine whether the estimated position is in the power-critical zone.

9. The apparatus of claim 8, wherein the apparatus is further caused to:
predict a position of the target;
determine whether the predicted position is in the power-limited zone or the power-critical zone;
predict a trajectory for the target based on the predicted position being in the power-critical zone, and
determine whether the predicted trajectory intersects with the power-limited zone.

10. The apparatus of claim 9, wherein the apparatus is further caused to identify a second network node based on the estimated position or the predicted position being in the power-limited zone; or based on the predicted trajectory intersecting with the power-limited zone.

11. The apparatus of claim 10, wherein the apparatus is further caused to:
determine a sensing services handover from the first network to the second network node;
transmit a sensing services initialization request to the second network node in order to enable the second network node to sense the target;
receive a confirmation for the sensing services initialization request from the second network node; and
transmit a sensing services release request to the first network node in order to disable the first network node from sensing the target.

12. The apparatus of claim 10, wherein the sensing services initialization request comprises the estimated position of the target; the estimated speed of the target; the estimated moving direction of the target; the orientation of the target; recommended link parameters.

13. The apparatus of claim 1, wherein the target is an unmanned aerial vehicle, UAV, or a drone.

14. A method comprising:
receiving, from a network node, a first information associated with a target in an environment, wherein the first information comprises one or more parameter estimates based on a reflection signal from the target;
receiving, from the network node, a second information associated with the environment and antenna characteristics of a transmission and reception point of the network node;
determining a three-dimensional map based on the second information;
estimating a position of the target based on the first information and the second information, the position representing a coordinate in the three-dimensional map; and
determining a power-limited zone based on the estimated position, wherein the power-limited zone represents restricted sensing capabilities of the network node for sensing the target.

15. A non-transitory computer-readable medium storing instructions, when executed by an apparatus, cause the apparatus to perform at least:
receiving, from a network node, a first information associated with a target in an environment, wherein the first information comprises one or more parameter estimates based on a reflection signal from the target;
receiving, from the network node, a second information associated with the environment and antenna characteristics of a transmission and reception point of the network node;
determining a three-dimensional map based on the second information;
estimating a position of the target based on the first information and the second information, the position representing a coordinate in the three-dimensional map; and
determining a power-limited zone based on the estimated position, wherein the power-limited zone represents restricted sensing capabilities of the network node for sensing the target.
